(19) United States
(12) Patent Application Publication
(10) Pub. No.: US 2013/0067713 A1
(43) Pub. Date: Mar. 21, 2013

(54) Assembly of a wooden lamp with detachable and re-attachable wooden corbels

(71) Applicant: Phillip Myer, Holt, MI (US)

(72) Inventor: Phillip Myer, Holt, MI (US)

(21) Appl. No.: 13/200,093

(22) Filed: Sep. 19, 2011

(51) Int. Cl. B23P 19/00

(52) U.S. Cl. 29/426.1

(57) ABSTRACT

Wooden lamp assemblies with detachable and re-attachable wooden corbels that support the lamp shade, the corbels being attachable and detachable to the base for shipping, and shade leveling convenience, the arms are attached between the body of the lamp base and shade with any number of dowel pins and screws.

### BACKGROUND OF THE INVENTION

1) Field of the Invention

The present invention relates to the wooden lamp assembly that has corbels (or wooden arms) that are permanently attached to a lamp base to support a wooden lamp shade. The invention involves corbels can be attached and detached easily for shipping, and leveling of the lamp shade using any combination of screws or screws, dowel pins and alignment markings.

2) Description of the Prior Art

In the past wooden lamp structures have had corbels that are glued to the base using a mortise and tennon joint or a woodscrew and glue joint. These 2 methods of attaching the wooden arm or corbel to the base are permanent, and did not allow easy breakdown for shipment and balancing of the shade to make it level with the surface it sits on.

Previously, when packaged in cartons, the corbels of the base would occupy substantial space and result in articles requiring excessive room during shipping. The larger box size needed would cost more money to ship, and be more likely to get damaged in shipping.

### SUMMARY OF THE INVENTION

The primary objective of the invention herein is to provide a do it yourself wooden lamp assembly whereas a lamp having removable wooden corbels can be shipped in smaller more convenient boxes and assembled by the customer. Several numbered or marked wooden lamp corbels are fitted into carrier holes on the base of the lamp, and screwed into place. The ends of these corbels are marked with an alignment dot to correspond with an alignment dot on the lamp shade so that the customer can then attach the shade to the base with 4 screws. These corbels provide support for the shade that is then placed on top of them. When assembly is finished by the customer the lamp is one entire assembly.

### BRIEF DESCRIPTION OF THE DRAWINGS

FIG. 1 is a perspective view of the lamp base and arms that support the shade

FIG. 2 is an exploded drawing of the invention herein.

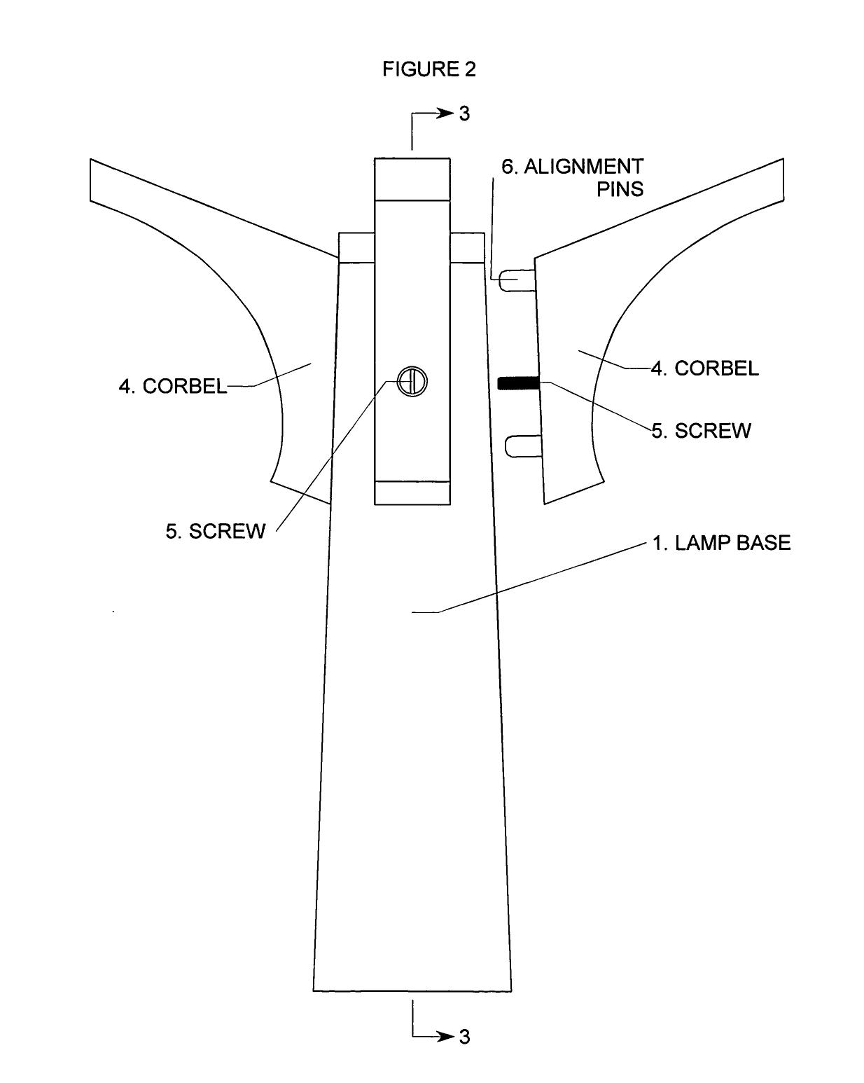

FIG. 3 is a cross-sectional drawing of the embodiment of the invention shown in FIGS. 1 and 2.

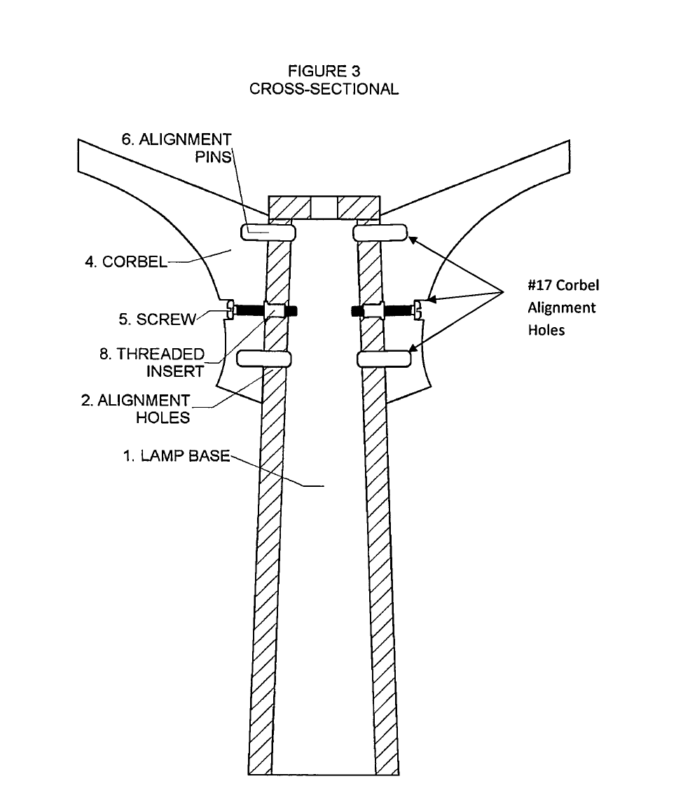

FIG. 4 is a drawing of the inside of a wooden lamp shade showing the alignment marking and the 4 screw holes used to attach the shade to the arms.

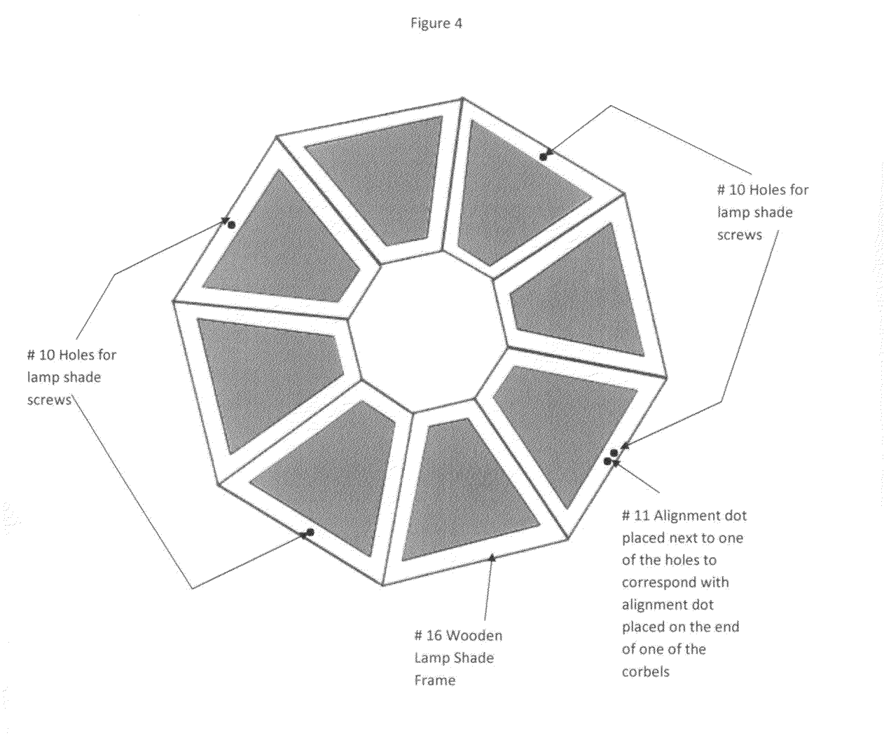

### DETAILED DESCRIPTION OF THE INVENTION

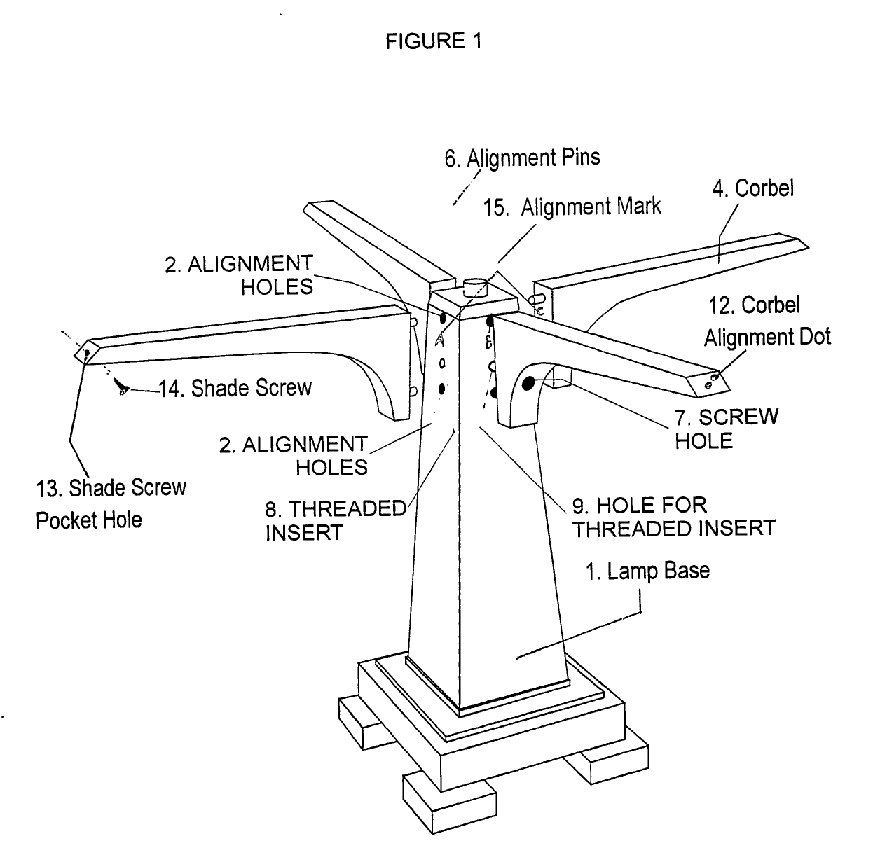

Referring to FIG. 1 the lamp base has three alignment holes (#2) drilled in each of the sides of the lamp base (#1). Two of the alignment holes are for receiving the alignment pin (or dowel pins) from the corbel, and the third alignment hole is for receiving a press-fit threaded insert (#8).

Referring to FIG. “3” three alignment holes are drilled in the corbel (#17) to match the spacing of the holes drilled in the lamp base. The two outside holes of the corbel will receive alignment pins that are glued in place, and the third alignment hole is a pocket hole for the machine screw used as a fastener to fasten the two sub-assemblies together. In this case the machine screw and the threaded insert both have 8-32 screw threads.

When the corbel is first fitted onto the lamp base at the wood shop where it is built, the alignment (#6) pins provide a tight fit so that there is only a small amount of movement, and when the screw is threaded into place the corbel is fastened tightly to the lamp base (#1). When all corbels are mounted to the lamp base in this manner they will provide strong support for the lamp shade.

The wooden lamp shade frame (#16) is then placed on top of the corbels (#4) and leveled. The lamp shade holes (#10) are drilled to accommodate the small lamp shade wood screws (#14), and the screws are turned into place.

After the assembly is inspected the wood screws of the shade (#14) are removed, and a small alignment dot (#12) is marked on one of the corbels and the corresponding alignment dot (#11) is placed on the matching lamp shade screw hole (#10). The corbels are then removed and marked with alignment markings (#15) to mark where they were positioned on the lamp base.

When the customer receives the lamp he or she places each corbel on the base where the corresponding alignment mark of “A” B” “C” or “D” or “1”, “2”, “3” and “4” is located, and screws each corbel in place. The customer then finds the alignment dot located on one of the corbels and matches up the alignment dot located on one of the holes of the lamp shade, and screws the corbels to the base using the lamp shade screws.

The lamp shade screws are small wood screws that fit through the pocket holes drilled in the corbels and thread into the wooden lamp shade frame.

These structural features provide for the alignment and fastening of the corbel or brace thereby minimizing the physical space needed for shipping the assembly. A reduction in storage and shipping dimensions is achieved, and it facilitates user convenience in do-it-yourself lamp assembly, while effectively allowing disassembly for replacement and repair.

List of Items in Drawings: #1 the lamp-base, the #2 alignment holes, item #4 the corbel, item #5 the screw, item #6 alignment pins, #7 The screw hole, #8 the threaded insert, #9 the hole for the threaded insert #10 lamp shade screw holes, #11 Lamp shade alignment dot, #12 corbel alignment dot, #13 Shade screw pocket hole, #14 Shade screw, #15 Alignment mark, #16 wooden lamp shade frame, #17 corbel alignment holes

What is claimed is:

1. A method for assembling and un-assembling a wooden lamp for shipping purposes using a removable and replaceable corbel. Many different combinations of screws and dowel pins can be used by another manufacturer to accomplish a removable and replaceable corbel. The wording and drawings in this patent are meant to cover any combination of screws and dowel pins, so that another manufactured cannot just use another combination of screws and dowel pins to circumvent the spirit of this patent for removable and replaceable corbels.

2. A method of assembling and un-assembling a wooden lamp for leveling purposes using a system of numbers or letters. Many different combinations of numbers or letters can be used by another manufacturer to accomplish a removable and replaceable corbel. The wording and drawings in this patent are meant to cover any combination of numbers or letters or other markings, so that another manufactured cannot just use another combination of numbers or letters or markings to circumvent the spirit of this patent for removable and replaceable corbels.
